(19) United States
(12) Patent Application Publication
(10) Pub. No.: US 2021/0178827 A1
(43) Pub. Date: Jun. 17, 2021

(54) NON-PNEUMATIC TIRE

(71) Applicant: Toyo Tire Corporation, Itami-shi (JP)

(72) Inventor: Hiroshi Tahara, Itami-shi (JP)

(73) Assignee: Toyo Tire Corporation, Itami-shi (JP)

(21) Appl. No.: 17/116,378

(22) Filed: Dec. 9, 2020

(30) Foreign Application Priority Data
Dec. 13, 2019 (JP) 2019-225724

(51) Int. Cl. B60C 11/03; B60C 7/20

(52) U.S. Cl. CPC B60C 11/0309; B60C 2011/0339; B60C 7/20

(57) ABSTRACT

A non-pneumatic tire includes: an inner annular portion; an outer annular portion provided concentrically on an outer side of the inner annular portion; a plurality of coupling portions coupling the inner annular portion and the outer annular portion to each other; a tread provided on an outer side of the outer annular portion; and a groove formed on the tread, wherein the groove includes a protrusion protruding inward of the groove from a groove sidewall.

### TECHNICAL FIELD

The present disclosure relates to a non-pneumatic tire.

### BACKGROUND ART

Generally, a plurality of grooves are formed on a tread of a tire. In such a tire, so-called stone holding in which stones are caught in the grooves during running sometimes occurs. The stone holding can cause cracks on bottoms of the grooves and sidewalls of the grooves, and can cause vibration and noise. In order to suppress the stone holding, for example, there are measures such as providing protrusions on the bottoms of the grooves as in the following Patent Document 1.

### PRIOR ART DOCUMENT

### Patent Document

Patent Document 1: JP-A-2016-199073

### SUMMARY OF THE INVENTION

### Problems to be Solved by the Invention

It is an object of the present disclosure to provide a non-pneumatic tire capable of suppressing the stone holding.

### Means for Solving the Problems

A non-pneumatic tire of the present disclosure includes: an inner annular portion; an outer annular portion provided concentrically on an outer side of the inner annular portion; a plurality of coupling portions coupling the inner annular portion and the outer annular portion to each other; a tread provided on an outer side of the outer annular portion; and a groove formed on the tread.

The groove includes a protrusion protruding inward of the groove from a groove sidewall.

### BRIEF DESCRIPTION OF THE DRAWINGS

FIG. 1 is a front view showing a non-pneumatic tire according to the present embodiment.

FIG. 2 is a cross-sectional view taken along a line A-A of the non-pneumatic tire of FIG. 1.

FIG. 3 is an enlarged view of a main part of the non-pneumatic tire of FIG. 2.

FIG. 4 is a view of a tread when viewed from an outer circumference thereof.

FIG. 5 is views for explaining a function to discharge a stone.

FIG. 6 is an enlarged view of a main part of a non-pneumatic tire according to another embodiment.

FIG. 7 is an enlarged view of a main part of a non-pneumatic tire according to still another embodiment.

FIG. 8 is an enlarged view of a main part of a non-pneumatic tire according to yet another embodiment.

FIG. 9 is an enlarged view of a main part of a non-pneumatic tire according to a further embodiment.

### MODE FOR CARRYING OUT THE INVENTION

Hereinafter, an embodiment of a non-pneumatic tire will be described with reference to the drawings.

The non-pneumatic tire T includes a support structure SS for supporting a load from a vehicle. The non-pneumatic tire T of the present disclosure just needs to include such a support structure SS as described above. A member corresponding to a tread, a reinforcing layer, members for accommodation to an axle and a rim, or the like may be provided on an outer side (outer circumference side) and an inner side (inner circumference side) of the support structure SS.

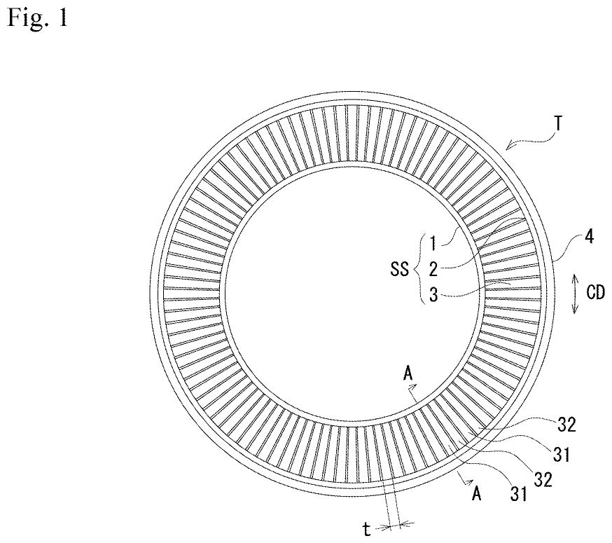

In the present embodiment, as shown in FIG. 1, a tread 4 is provided outside the support structure SS. The tread 4 is made of, for example, rubber as in the conventional pneumatic tire, and includes a pattern (groove) on an outer circumferential surface thereof as in the conventional pneumatic tire. The support structure SS and the tread A are adhered to each other by an adhesive.

As shown in a front view of FIG. 1, in the non-pneumatic tire T of the present embodiment, the support structure SS includes: an inner annular portion 1; an outer annular portion 2 provided concentrically on an outer side of the inner annular portion 1; and a plurality of coupling portions 3 which couple the inner annular portion 1 and the outer annular portion 2 to each other.

The support structure SS in the present disclosure is formed of an elastic material. From a viewpoint of enabling integral molding at the time of manufacturing the support structure SS, it is preferable that the inner annular portion 1, the outer annular portion 2, and the coupling portion 3 be basically made of the same material except a reinforcing structure. Moreover, for example, as a base material of the support structure SS, there may be adopted a thermoplastic elastomer such as polyester elastomer, a crosslinked rubber such as natural rubber, or other resins (for example, a thermoplastic resin such as polyethylene resin, and a thermosetting resin such as polyurethane resin). Furthermore, for example, a reinforcing material such as a fiber or a metal cord may be embedded inside the base material.

From a viewpoint of improving uniformity, it is preferable that the inner annular portion 1 have a cylindrical shape with a constant thickness. Moreover, on an inner circumferential surface of the inner annular portion 1, it is preferable to provide irregularities and the like for maintaining fitting property in order to mount the non-pneumatic tire T to the axle and the rim. Note that, though the thickness of the inner annular portion 1 is not particularly limited, the thickness is appropriately set from viewpoints of reducing a weight and improving a durability while sufficiently transmitting force to the coupling portion 3.

Although an inner diameter of the inner annular portion 1 is not particularly limited, the inner diameter is appropriately determined according to dimensions of the rim and the axle on which the non-pneumatic tire T is to tee mounted, and the like. Although a width of the inner annular portion 1 in a tire width direction WD is not particularly limited, the width is appropriately determined depending on a purpose, a length of the axle, and the like.

From the viewpoint of improving the uniformity, it is preferable that the outer annular portion 2 have a cylindrical shape with a constant thickness. Note that, though the thickness of the outer annular portion 2 is not particularly limited, the thickness is appropriately set from the viewpoints of reducing the weight and improving the durability while sufficiently transmitting force from the coupling portion 3.

Although an inner diameter of the outer annular portion 2 is not particularly limited, the inner: diameter is appropriately determined depending on the purpose and the like. Moreover, though a width of the outer annular portion 2 in the tire width direction WD is not particularly limited, the width is appropriately determined depending on the purpose and the like. Note that, preferably, the width of the outer annular portion 2 is the same as the width of the inner annular portion 1.

The coupling portions 3 couple the inner annular portion 1 and the outer annular portion 2 to each other. A plurality of the coupling portions 3 are provided so as to be independent of one another in the tire circumferential direction CD by placing appropriate intervals between the coupling portions 3. Although the number of coupling portions 3 is not particularly limited, the number is appropriately set from viewpoints of reducing the weight, improving power transmission, and improving the durability while sufficiently supporting the load from the vehicle.

The plurality of coupling portions 3 are configured such that first coupling portions 31 and second coupling portions 32 are arrayed along the tire circumferential direction CD. In this case, it is preferable that the first coupling portions 31 and the second coupling portions 32 be arrayed alternately with each other along the tire circumferential direction CD. This makes it possible to further reduce dispersion of the ground contact pressure during tire rolling.

From the viewpoint of improving the uniformity, it is preferable that a pitch in the tire circumferential direction CD between the first coupling portions 31 and the second coupling portions 32 be set constant.

Each of the first coupling portions 31 is extended from one side WD1 in the tire width direction of the inner annular portion 1 toward other side WD2 in the tire width direction of the outer annular portion 2. Meanwhile, each of the second coupling portions 32 is extended from the other side WD2 in the tire width direction of the inner annular portion 1 toward the one side WD1 in the tire width direction of the outer annular portion 2. That is, the first coupling portion 31 and the second coupling portion 32, which are adjacent to each other, are disposed in a substantially X shape when viewed from the tire circumferential direction CD.

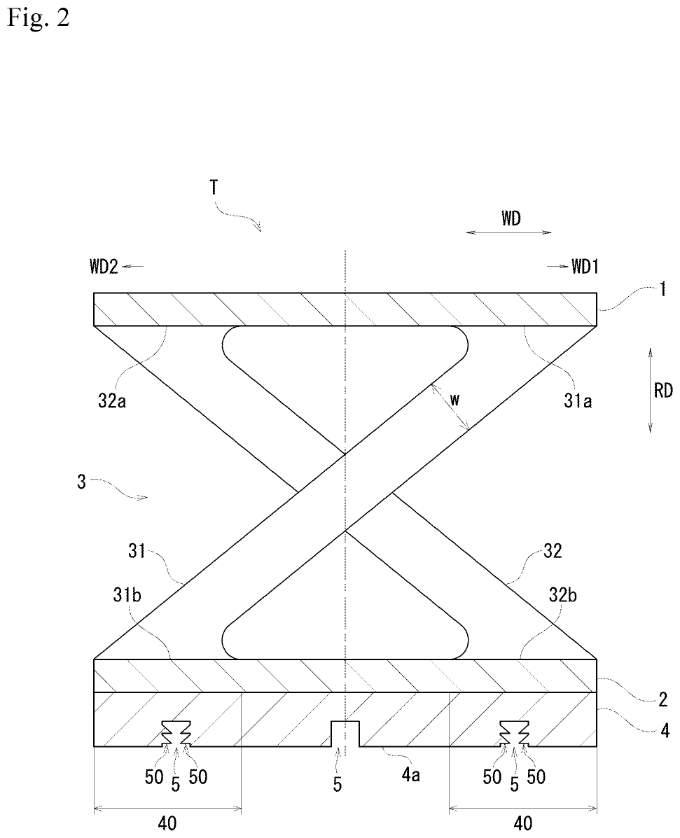

The first coupling portion 31 and the second coupling portion 32 when viewed from the tire circumferential direction CD are preferably symmetric to each other with respect to a tire equatorial plane as shown in FIG. 2. Therefore, hereinafter, the first coupling portion 31 will mainly be described.

The first coupling portion 31 has an elongated plate-like shape extending from the inner annular portion 1 to the outer annular portion 2. In the first coupling portion 31, a plate thickness t is smaller than a plate width w, and a plate thickness direction is oriented to the tire circumferential direction CD. That is, the first coupling portion 31 has a plate shape extending in the tire radial direction RD and in the tire width direction WD. The first coupling portion 31 and the second coupling portion 32 are formed into such an elongated plate shape. In this way, even if the plate thickness t is reduced, the first coupling portion 31 and the second coupling portion 32 can obtain desired rigidity by setting the plate width w to be wide. Therefore, the durability can be improved. Moreover, the number of first coupling portions 31 and the number of second coupling portions 32 are increased while thinning the plate thickness t. In this way, gaps between the coupling portions adjacent to one another in the tire circumferential direction CD can be reduced while maintaining the rigidity of the entire tire. Therefore, the dispersion of the ground contact pressure during the tire rolling can be reduced.

Although the thickness t is not particularly limited, the thickness t is appropriately set from the viewpoints of reducing the weight and improving the durability while sufficiently transmitting force from the inner annular portions 1 and the cuter annular portions 2. Although the plate width W is not particularly limited, the plate width w is appropriately set from the viewpoints of reducing the weight and improving the durability while sufficiently transmitting force from the inner annular portions 1 and the outer annular portions 2.

The first coupling portion 31 includes an inner connecting portion 31a connected to the inner annular portion 1 and an outer connecting portion 31b connected to the outer annular portion 2.

Although a shape of the inner connecting portion 31a is not particularly limited, the inner connecting portion 31a is formed into a rectangular shape in the present embodiment. A longitudinal direction of the inner connecting portion 31a is parallel to the tire width direction WD. Note that the longitudinal direction of the inner connecting portion 31a does not have to be parallel to the tire width direction WD, and for example, may intersect the tire width direction WD.

Although a shape of the outer connecting portion 31b is not particularly limited, the outer connecting portion 31b is formed into a rectangular shape in the present embodiment. A longitudinal direction of the outer connecting portion 31b is parallel to the tire width direction WD. Note that the longitudinal direction of the outer connecting portion 31b does not have to be parallel to the tire width direction WD, and for example, may intersect the tire width direction WD.

A tread surface 4a of the tread 4 of the present embodiment is parallel to the tire width direction WD and is flat from one end to the other end in the tire width direction WD. The tread surface 4a of the tread 4 does not necessarily have to be flat and may have a curvature. However, the curvature of the tread surface 4a is preferably small, and for example, a radius of curvature of the tread surface 4a is preferably 490 mm or more, more preferably 810 mm or more. The radius of curvature here is a radius of curvature when the tread surface 4a has one curvature, or is a radius of curvature of a curvature closest to the tire equatorial plane when the tread surface 4a has a plurality of curvatures along the tire width direction WD. Moreover, a difference between a maximum outer diameter and minimum outer diameter of the tread surface 4a is preferably 10 mn or less, more preferably 6 mm or less. Usually, the maximum outer diameter of the tread surface 4a is an outer diameter of the tread surface 4a on the tire equatorial plane, and the minimum outer diameter of the tread surface 4a is an outer diameter of the tread surface 4a on both ends in the tire width direction WD.

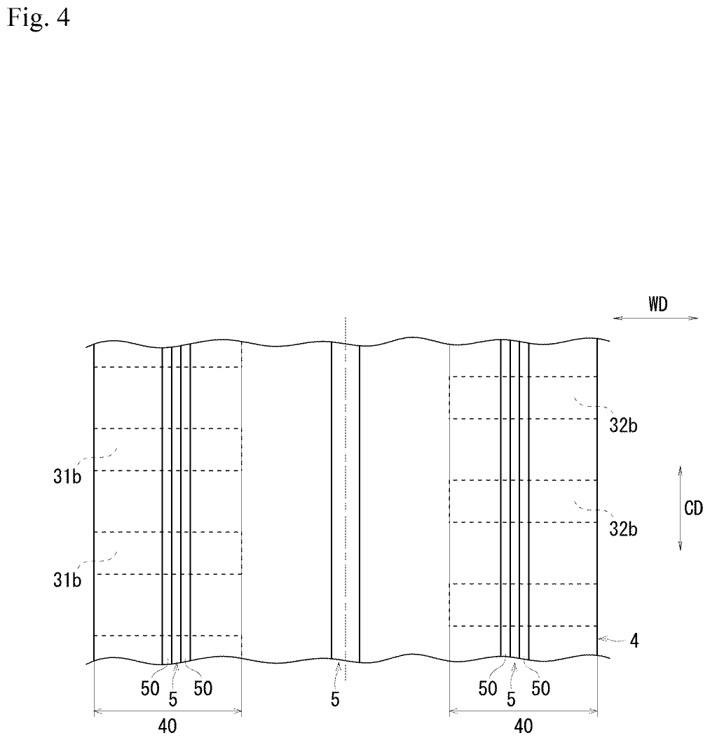

FIG. 4 is a view of the tread 4 when viewed from an outer circumference thereof. Portions shown by broken lines in FIG. 4 are outer connecting portions 31b and 32b. The tread 4 includes annular connecting portion regions 40 and 40 located outward of the outer connecting portions 31b and 32b in the tire radial direction. The connecting portion regions 40 and 40 overlap the outer connecting portions 31b and 32b in the tire radial direction RD when viewed from the tire circumferential direction CD.

A plurality of grooves are formed on the outer circumferential surface of the tread 4. In the present embodiment, three main grooves 5 extending in the tire circumferential direction CD are formed. The main groove 5 is formed on a center of the tread 4 in the tire width direction WD and on the connecting portion regions 40 and 40. The main grooves 5 may be aligned with the tire circumferential direction CD, may be inclined with respect thereto, or may be zigzag as long as extending in the tire circumferential direction CD. Lateral grooves extending in the tire width direction WD may be formed on the outer circumferential surface of the tread 4. The lateral grooves may be aligned with the tire width direction WD or may be inclined with respect thereto as long as extending in the tire width direction WD.

Cross section of the main grooves 5 have a rectangular shape. However, the cross sections of the main grooves 5 are not limited to such a rectangular shape, and may have a trapezoidal shape in which groove bottoms are narrower than groove openings. Each of the main grooves 5 includes groove sidewalls 5a and 5a extending along the tire radial direction RD, and a groove bottom 5b coupling inner ends of both of the groove sidewalls 5a in the tire radial direction to each other. The groove sidewalls 5a and 5a are flat surfaces passing through an end of the groove opening and an end of the groove bottom 5b.

The main groove 5 includes protrusions 50 protruding inward of the groove from the groove sidewalls 5a. The main groove 5 includes the protrusions 50 individually protruding from both of the groove sidewalls 5a. In the present embodiment, among the three main grooves 5, only the main grooves 5 located on the connecting portion regions 40 and 40 include the protrusions 50.

The main grooves 5 include the protrusions 50, whereby stones can be suppressed from entering the main groove from the groove openings, and the stone holding can be suppressed. Moreover, the main grooves 5 include the protrusions 50, whereby, even if stones enter the same, a direct contact between the groove sidewalls 5a and the stones can be prevented, and a crack in the groove sidewalls 5a can be prevented.

Further, the protrusions 50 also have a function to discharge a stone that has entered each of the main grooves 5. When the tread surface 4a of the tread 4 has a curvature like a general pneumatic tire, stones are caught in the main groove 5 due to narrowing of a groove width of the main groove 5 when the tire touches the ground, but as the tire rolls, a groove width of the main groove 5 returns to an original value thereof, and the stones are discharged by centrifugal force. On the other hand, when the tread surface 4a of the tread 4 is flat or substantially flat, the groove width of the main groove 5 is almost the same no matter whether or not the tire touches the ground, and accordingly, force to discharge the held stones is weak, but the discharge of the stones can be urged by the protrusions 50.

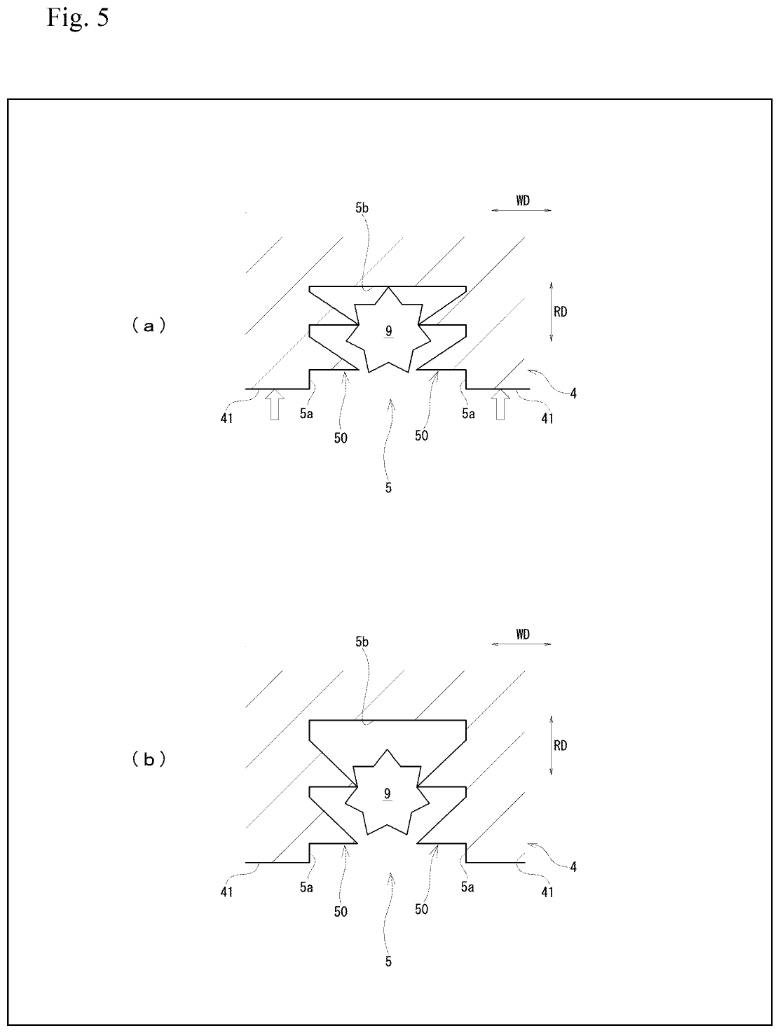

A specific function to discharge a stone by the protrusions 50 will be described with reference to FIG. 5. When the tread surface 4a of the tread 4 is flat or substantially flat, the groove width of the main groove 5 is almost unchanged when the tire touches the ground, and as shown in FIG. 5(a), lands 41 on both sides of the main groove 5 are compressed in the tire radial direction RD. Along with this, the protrusions 50 are moved inward (toward the groove bottom) in the tire radial direction and enter an inside of a stone 9 in the tire radial direction. Thereafter, when a compression load on the lands 41 is released as the tire rolls, the protrusions 50 are moved outward (toward the opening) in the tire radial direction as shown in FIG. 5(b), and exert the function to discharge the stone 9.

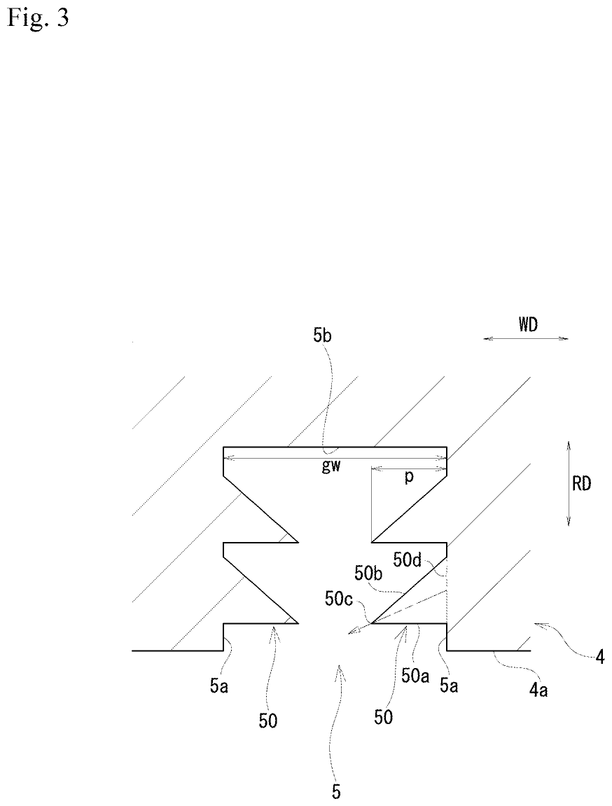

As shown in FIG. 3, a cross section of each of the protrusions 50 is triangular, and the protrusion 50 includes a protrusion outer surface 50a facing outward in the tire radial direction and a protrusion inner surface 50b facing inward in the tire radial direction. The protrusion outer surface 50a is substantially parallel to the tire width direction WD. On the other hand, the protrusion inner surface 50b is inclined so as to approach the groove sidewall 5a toward the groove bottom 5b with respect to the tire radial direction RD corresponding to a depth direction of the main groove 5. That is, the protrusion 50 is provided so that the groove width becomes wider toward the groove bottom 5b by the protrusion inner surface 50b.

The protrusion 50 protrudes toward the opening of the main groove 5. In other words, a protrusion direction of the protrusion 50 (indicated by an arrow in FIG. 3) is inclined with respect to the tire width direction WD so as to approach the groove opening toward a tip 50c of the protrusion 50. The protrusion direction of the protrusion 50 is a direction from a center of a proximal end 50d toward a center of the tip 50c. The protrusion 50 protrudes toward the opening of the main groove 5, whereby the protrusion 50 becomes a “guard” and can effectively suppress the entrance of a stone, while a stone that has entered the main groove 5 is easily discharged.

The main groove 5 may include a plurality of the protrusions 50 along the depth direction of the main groove 5. In the present embodiment, cross sections of the plurality of protrusions 50 have a sawtooth shape. The plurality of protrusions 50 may have the same shape or may have different shapes from one another. For example, the protrusion 50 closer to the opening of the main groove 5 may be smaller than the protrusion 50 closer to the groove bottom.

Further, when only one protrusion 50 is provided along the depth direction of the main groove 5, the entrance of a stone can be effectively suppressed if the protrusion 50 is located closer to the opening than the center of the groove sidewall 5a in the depth direction, and meanwhile, a stone can be effectively discharged if the protrusion 50 is located closer to the groove bottom than the center of the groove sidewall 5a in the depth direction.

The protrusions 50 may be continuously provided along the direction in which the main groove 5 extends. In the present embodiment, the protrusions 50 are continuously provided along the tire circumferential direction CD. However, the protrusions 50 do not have to be continuously provided along the tire circumferential direction CD, and may be provided intermittently. For example, one protrusion 50 may be provided for each repeating pitch of a tread pattern.

A length (protrusion amount) p from the groove sidewall 5a to the tip 50c is preferably 20% or more, more preferably 30% or more of the groove width gw. Further, the protrusion amount p is preferably 45% or less, more preferably 40% or less of the groove width gw.

As described above, the non-pneumatic tire T according to the present embodiment includes: the inner annular portion 1; the outer annular portion 2 provided concentrically on the outer side of the inner annular portion 1; the plurality of coupling portions 3 coupling the inner annular portion 1 and the outer annular portion 2 to each other; the tread 4 provided on the outer side of the outer annular portion 2; and the main groove 5 formed on the tread 4,

wherein the main groove 5 includes the protrusions 50 protruding inward of the groove from the groove sidewall 5a.

According to this non-pneumatic tire T, the main grooves 5 include the protrusions 50, whereby a stone can be suppressed from entering the main groove from each of the groove openings, and the stone holding can be suppressed.

Further, in the non-pneumatic tire T according to the present embodiment, the protrusions 50 may be configured to protrude toward the opening of each of the main grooves 5. With this configuration, the protrusion 50 becomes a “guard” and can effectively suppress the entrance of a stone, while a stone that has entered the main groove 5 is easily discharged.

Further, in the non-pneumatic tire T according to the present embodiment, the main groove 5 may include a plurality of the protrusions 50 along the groove depth direction. With this configuration, a stone can be effectively suppressed from entering the main groove from the groove opening.

Further, in the non-pneumatic tire T according to the present, embodiment, the main groove 5 may include protrusions 50 protruding from both of the groove sidewalls 5a. With this configuration, a stone can be effectively suppressed from entering the main groove from the groove opening.

Further, in the non-pneumatic tire T according to the present embodiment, the main grooves 5 including the protrusions 50 may be formed in the connecting portion regions 40 located on the outer side in the tire radial direction of the outer connecting portions 31b and 32b of the coupling portions 3 and the outer annular portion 2. Since the ground contact pressure is high in the connecting portion regions 40 located on the outer side of the outer connecting portions 31b and 32b in the tire radial direction, damage due to the stone holding is likely to increase. Therefore, the main grooves 5 formed on the connecting portion regions 40 include the protrusion 50, whereby it is possible to focus on measures against the stone holding in the connecting portion regions 40.

Further, in the non-pneumatic tire T according to the present embodiment, the protrusions 50 may be continuously provided along the extending direction of the main grooves 5. With this configuration, the stone holding can be effectively suppressed in the entire tire.

Although the embodiments of the present disclosure have been described above with reference to the drawings, it should be considered that the specific configurations are not limited to these embodiments. The scope of the present disclosure is shown not only by the above description of the embodiments but also by the claims, and further includes all modifications within the meanings and the scope, which are equivalent to those in the claims.

It is possible to adopt the structure adopted in each of the above embodiments in any other embodiment. The specific configuration of each of the portions is not limited to the above-described embodiments, and various modifications are possible without departing from the spirit of the present disclosure.

The non-pneumatic tire is not limited to the configuration of the above-described embodiments, and is not limited to the above-described functions and effects. Moreover, as a matter of course, the non-pneumatic tire can be modified in various ways within the scope without departing from the spirit of the present invention. For example, as a matter of course, the respective configurations, the respective methods and the like of the above-described plurality of embodiments may be arbitrarily adopted and combined (the respective configurations, the respective methods and the like according to one embodiment may be applied to a configuration, a method and the like according to another embodiment). Moreover, as a matter of course, one or a plurality of configurations, methods and the like according to the following various modification examples may be arbitrarily selected and adopted for the configurations, the methods and the like according to the above-described embodiments.

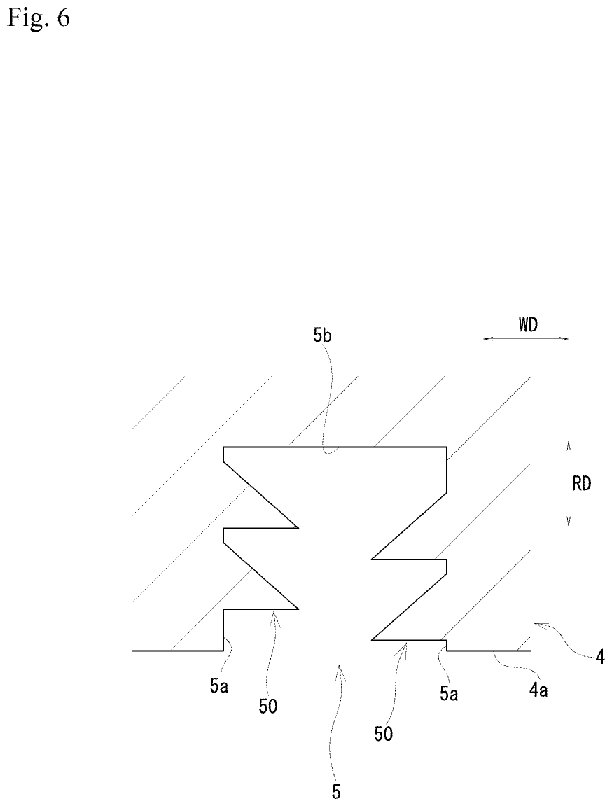

(1) In the non-pneumatic tire T according to the above embodiment, the protrusions 50 and 50 protruding from both of the groove sidewalls 5a and 5a are provided at the same positions in the depth direction of each of the main grooves 5, but the present disclosure is not limited to this. For example, as shown in FIG. 6, the protrusions 50 and 50 protruding from both of the groove sidewalls 5a and 5a may be provided at different positions in the depth direction of the main groove 5.

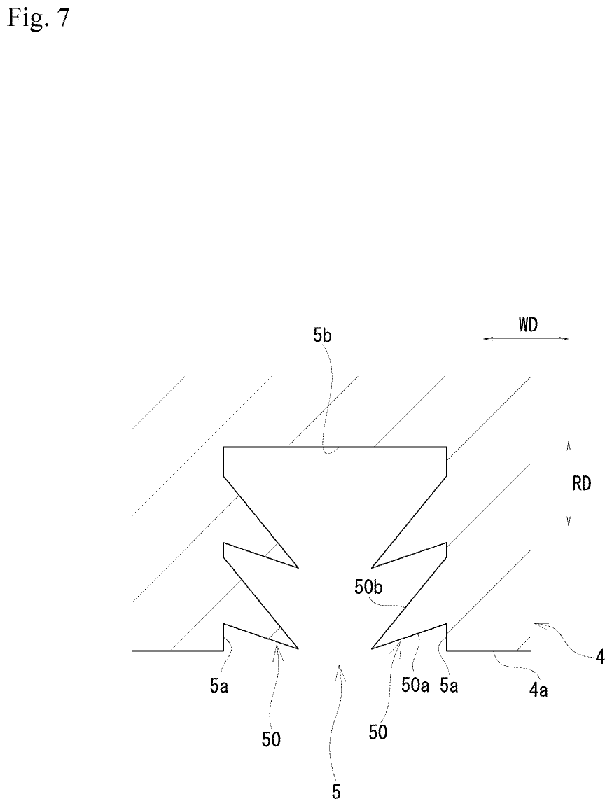

(2) Further, in the non-pneumatic tire T according to the above embodiment, the protrusion outer surface 50a of the protrusion 50 is substantially parallel to the tire width direction WD, but the present disclosure is not limited to this. For example, as shown in FIG. 7, similarly to the protrusion inner surface 50b, the protrusion outer surfaces 50a may be inclined with respect to the tire radial direction RD so as to approach the groove sidewalls 5a toward the groove bottom 5b. With this configuration, a stone can be effectively suppressed from entering the main groove from the groove opening.

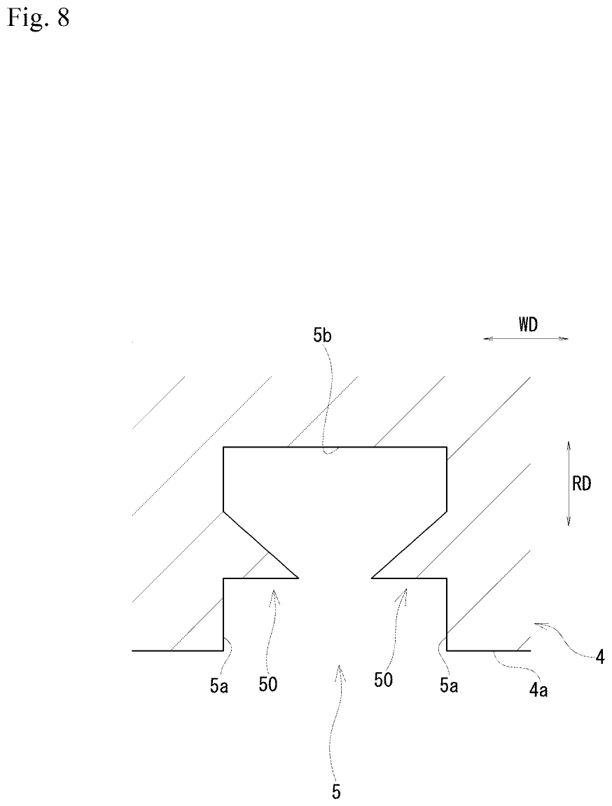

(3) Further, in the non-pneumatic tire T according to the above embodiment, the main groove 5 includes a plurality of the protrusions 50 along the groove depth direction of the main groove 5, but the present disclosure is not limited to this. For example, as shown in FIG. 8, the main groove 5 may include only one protrusion 50 in the depth direction of the main groove 5. When a plurality of the protrusions 50 are provided, the protrusion 50 on the outer side in the tire radial direction may hinder the function to discharge a stone by the protrusions 50 formed on the inner side in the tire radial direction, but the one protrusion 50 does not hinder such a discharge function.

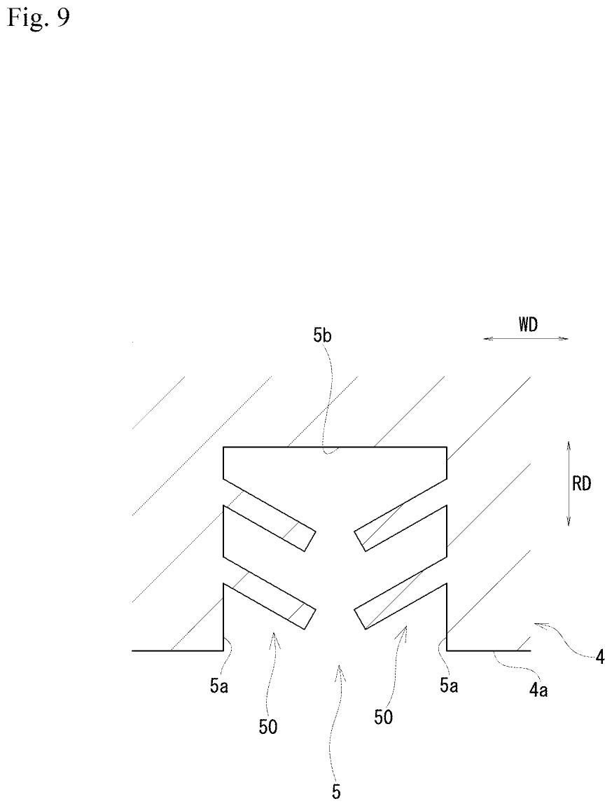

(4) Further, in the non-pneumatic tire T according to the above embodiment, the cross section of the protrusion 50 is triangular, but the present disclosure is not limited to this. For example, as shown in FIG. 9, the cross section of the protrusion 50 may be rectangular.

(5) Further, in the non-pneumatic tire T according to the above embodiment, the protrusions 50 are continuously provided along the extending direction of the main groove 5, but the present disclosure is not limited to this. Drainage can be ensured by intermittently providing the protrusions 50 along the extending direction of the main groove 5. Further, the protrusions 50 may be provided mainly near an intersection of the main groove 5 and an auxiliary groove.

(6) Further, in the non-pneumatic tire T according to the above embodiment, the main groove 5 formed on the center of the tread 4 in the tire width direction does not have the protrusion 50, but may have the protrusion 50. At this time, the main groove 5 on the center of the tread 4 in the tire width direction may include only one protrusion 50 in the depth direction of the main groove 5, and the main groove 5 of each of the connecting portion regions 40 may include a plurality of the protrusions 50 in the depth direction of the main groove 5. Further, the auxiliary groove may include the protrusion 50.

(7) Further, in the non-pneumatic tire T according to the above embodiment, the plurality of coupling portions 3 are configured such that the first coupling portions 31 and the second coupling portions 32 are arrayed along the tire circumferential direction CD, but the shape of the coupling portions 3 is not particularly limited. For example, the coupling portions 3 may have a rectangular plate shape or the like which couples the inner annular portion 1 and the outer annular portion 2 to each other.

### DESCRIPTION OF REFERENCE SIGNS

T Non-pneumatic tire

SS Support structure

1 Inner annular portion

2 Outer annular portion

3 Coupling portion

4 Tread

4a Tread surface

5 Main groove

5a Groove sidewall

5b Groove bottom

31 First coupling portion

31a Inner connecting portion

31b Outer connecting portion

32 Second coupling portion

32b Outer connecting portion

40 Connecting portion region

41 Land

50 Protrusion

50a Protrusion outer surface

50b Protrusion inner surface

50c Tip

50d Proximal end p CD Tire circumferential direction

RD Tire radial direction

WD Tire width direction

1. A non-pneumatic tire comprising:
an inner annular portion;
an outer annular portion provided concentrically on an outer side of the inner annular portion;
a plurality of coupling portions coupling the inner annular portion and the outer annular portion to each other;
a tread provided on an outer side of the outer annular portion; and
a groove formed on the tread,
wherein the groove includes a protrusion protruding inward of the groove from a groove sidewall.

2. The non-pneumatic tire according to claim 1, wherein the protrusion protrudes toward an opening of the groove.

3. The non-pneumatic tire according to claim 1, wherein the groove includes a plurality of the protrusions along a groove depth direction.

4. The non-pneumatic tire according to claim 1, wherein the groove includes the protrusions protruding from both of groove sidewalls.

5. The non-pneumatic tire according to claim 1, wherein the groove including the protrusion is formed in a connecting portion region located on an outer side in a tire radial direction of the connecting portions of the coupling portions and the outer annular portion.

6. The non-pneumatic tire according to claim 1, wherein the protrusion is continuously provided along an extending direction of the groove.

7. The non-pneumatic tire according to claim 1,
wherein a cross section of the protrusion has a triangular shape, and
wherein the protrusion includes a protrusion outer surface facing outward in a tire radial direction and a protrusion inner surface facing inward in the tire radial direction, and the protrusion inner surface is inclined with respect to the tire radial direction so as to approach the groove sidewall toward a groove bottom of the groove.

8. The non-pneumatic tire according to claim 7, wherein the protrusion outer surface is substantially parallel to a tire width direction.

9. The non-pneumatic tire according to claim 7, wherein the protrusion outer surface is inclined with respect to the tire radial direction so as to approach the groove sidewall toward the groove bottom of the groove.

10. The non-pneumatic tire according to claim 4, wherein the protrusions protruding from both of the groove sidewalls are provided at different positions in a groove depth direction of the groove.
